(19) United States
(12) Patent Application Publication
(10) Pub. No.: US 2025/0363337 A1
(43) Pub. Date: Nov. 27, 2025

(54) TRAINING GENERATIVE NEURAL NETWORKS USING SOFT PREFERENCES

(71) Applicant: GDM Holding LLC, Mountain View, CA (US)

(72) Inventors: Hiroki Furuta, Tokyo (JP); Kuang-Huei Lee, San Francisco, CA (US); Shixiang Gu, Cambridge (GB); Aleksandra Faust, Palo Alto, CA (US); Izzeddin Gur, San Jose, CA (US)

(21) Appl. No.: 19/216,603

(22) Filed: May 22, 2025

Related U.S. Application Data
(60) Provisional application No. 63/650,865, filed on May 22, 2024.

(51) Int. Cl. G06N 3/0475; G06N 3/047; G06N 3/088; G06N 3/09

(52) U.S. Cl. CPC G06N 3/0475; G06N 3/047; G06N 3/088; G06N 3/09

(57) ABSTRACT

Methods, systems, and apparatus, including computer programs encoded on a computer storage medium, for training a generative machine learning machine learning models to perform a machine learning task. In one aspect, a method comprises receiving an input prompt; and processing the input prompt using a generative neural network to generate the data item, wherein the generative neural network is optimized to generate output data items in response to input prompts, the neural network being optimized such that a contribution of preference data to an objective function used for optimizing the generative neural network is determined based on a preference score associated with the preference data, the preference data comprising a first training data item, a second training data item, a training prompt, and the preference score representing a degree of preference for the first training data item over the second training data item as a response to the training prompt.

### CROSS-REFERENCE TO RELATED APPLICATION

This application claims priority to U.S. Provisional Application No. 63/650,865, filed on May 22, 2024. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes systems and methods implemented as computer programs on one or more computers in one or more locations that can train a generative neural network (“target generative neural network”) using “soft preferences” to adapt a data item generation policy of the generative neural network to the soft preferences. That is, this specification describes techniques for training the generative neural network so that output data items better reflect the soft preferences.

The preferences are referred to as “soft” because the set of training examples the system uses to train the generative neural network each include (i) a first training data item, (ii) a second training data item, (iii) a training prompt, and (iv) a preference score indicating a degree to which the first training data item is preferred over the second training data item as a response to the training prompt. That is, unlike other approaches that use a “hard” preference in which the training examples indicate only that the first training data item is preferred to the second training data item, this specification describes techniques for using preference scores which are non-binary, i.e., not only equal to zero or one, to represent soft preferences between training data items.

The target generative neural network can be configured to perform a machine learning task and the training examples for training the target generative neural network can include example prompts and example data items for performing the machine learning task.

As one example, the machine learning task can involve interacting with a user to perform the task, e.g., by generating responses to queries received from the user. When the machine learning task involves interacting with a user, the example prompt for a training example can include examples of queries from an example user and the example data items for the training example can include example responses to the examples of queries from the example user.

As another example, the machine learning task can be to select actions for an agent interacting with an environment to perform a task in the environment. The example data items for a training example can include example selected actions for an example agent to perform the task in an example environment for the training example. The example prompts can include example observations of the example environment for the training example.

The subject matter described in this specification can be implemented in particular embodiments so as to realize one or more of the following advantages.

The described systems and methods enable efficient fine-tuning and alignment of generative neural networks using feedback (e.g., human feedback) regarding the quality of example outputs. Fine-tuning using human feedback can enable generative neural networks to learn human preferences regarding model outputs and to generate more preferable outputs. Fine-tuning large generative neural networks, such as large language models (LLMs) and vision-language models (VLMs), with human feedback is particularly useful in many applications, as these large models can have the computational capability of accurately modeling human preferences and of generating high quality outputs.

Conventional methods for fine-tuning using feedback, such as reinforcement learning from human feedback (RLHF) or direct policy optimization (DPO), typically fine-tune generative neural networks using training data demonstrating “hard” pair-wise preferences between example outputs that indicate a binary preference between a pair of example outputs. Conventional methods therefore typically utilize training examples that each include an example input (e.g., an example prompt), two example data items (e.g., example responses or prompt completions), and data specifying a preference (e.g., a human preference) between the two example outputs. Thus, these conventional approaches use a “hard” preference in which the training examples indicate only that the first training data item is preferred to the second training data item in the training example.

The described techniques, on the other hand, train the generative neural network (“target generative neural network”) using “soft preferences” to adapt a data item generation policy of the generative neural network to the soft preferences. That is, this specification describes techniques for training the generative neural network so that output data items better reflect the soft preferences.

The preferences are referred to as “soft” because the set of training examples the system uses to train the generative neural network each include (i) a first training data item, (ii) a second training data item, (iii) a training prompt, and (iv) a preference score indicating a degree to which the first training data item is preferred over the second training data item as a response to the training prompt. The preference score can be a value between zero and one. That is, unlike other approaches that use a “hard” preference in which the training examples indicate only that the first training data item is preferred to the second training data item, this specification describes techniques for using preference scores which are non-binary, i.e., not only equal to zero or one, to represent soft preferences between training data items.

By making use of soft preferences, the system can more effectively train the neural network than systems that rely on hard preferences. In particular, soft preference data may be more readily available (or more readily generated) than hard preference data and can more accurately reflect the actual preference of users or other systems between data items generated by the system. As a result, the system can train the neural network on more and higher-quality data, resulting in a higher-performing neural network.

By more efficiently fine-tuning generative neural networks, the described systems can be used to reduce training and inference costs (e.g., computational time, memory usage, etc.). For example, training using soft preferences can enable the described systems to more efficiently train (e.g., using fewer training examples, over fewer training iterations, etc.) a same generative neural network to a desired level of performance in the machine learning task as compared to conventional training methods that utilize hard preference data. As another example, training using soft preferences can enable the described systems to train a smaller, less complex generative neural network to attain a desired level of performance as compared to conventional training methods that utilize hard preference data, which can further reduce computational costs of both training and inference of the model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 shows an example of a training example.

FIG. 3 is a flow diagram of an example process for training the generative neural network.

FIG. 4 illustrates an example of the performance of example generative neural networks that have been trained using the described techniques.

Like reference numbers and designations in the various drawings indicate like elements.

### DETAILED DESCRIPTION

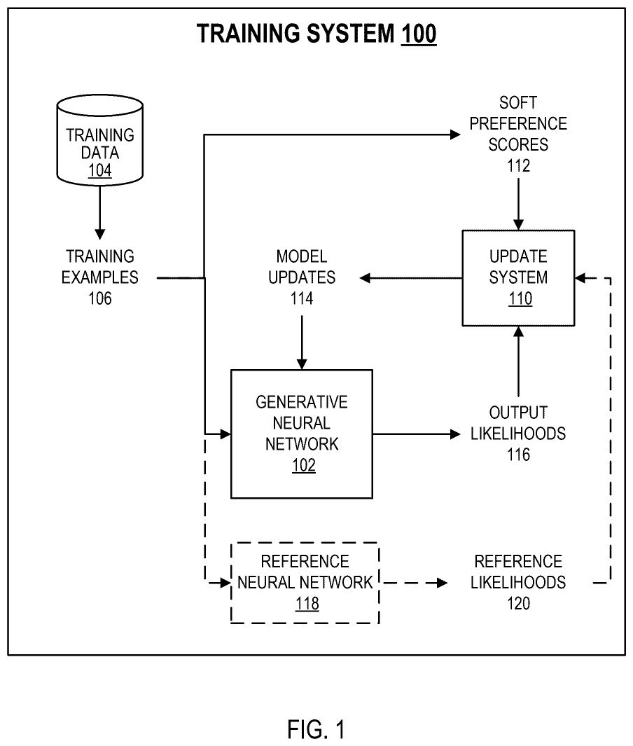

FIG. 1 shows an example training system 100. The training system 100 is an example of a system implemented as computer programs on one or more computers in one or more locations in which the systems, components, and techniques described below are implemented.

The training system 100 can train a generative neural network 102 (e.g., a target generative neural network) to perform a machine learning task using a set of training data 104 for the machine learning task.

The machine learning task can be any of a variety of tasks. For example, the machine learning task can include receiving an input query (e.g., an input prompt) from a user and processing the received query to generate an output as a response to the received query. The machine learning task can include, e.g., generating output text, an output image, output audio, an output video, and so on in response to a user query. As another example, the machine learning task can include selecting actions for an agent interacting with an environment to perform a task in the environment. As a further example, the machine learning task can include processing data characterizing the environment (e.g., data characterizing an observation of the environment) as a model input to generate a selected action for the agent as the model output. More generally, the output generated by the generative neural network 102 will be referred to as a “data item.” The data item can be of any appropriate modality, e.g., text, audio, video, image, or can be a multi-modal output that includes two or more different modalities.

The generative neural network 102 can have any appropriate architecture for processing input prompts (e.g., model inputs) for the machine learning task to generate output data items (e.g., model outputs) for the machine learning task. In particular, the generative neural network 102 can be a neural network that includes any of a variety of processing layers (e.g., feedforward layers, convolutional layers, recurrent layers, attention layers, graph processing layers, etc.) in any appropriate combination for performing the machine learning task.

For example, the generative neural network 102 can be a sequence processing neural network configured to generate output sequences (e.g., output token sequences) representing output data items for machine learning task by processing input sequences (e.g., input token sequences) representing input prompts for machine learning task. As a further example, the generative neural network 102 can be an auto-regressive generative neural network (e.g., a Transformer, a recurrent neural network, etc.) that can auto-regressively generate output sequences for the machine learning task. A transformer neural network is a neural network that includes a stack of transformer blocks, each typically including an attention or self-attention neural network layer, generally followed by a feedforward neural network layer (where a self-attention neural network layer applies a self-attention operation, e.g., QKV self-attention, to elements of an embedding, to update each element of the embedding).

The generative neural network 102 can, for example, be a large language model (LLM) that can generate tokenized representations of text data; a vision-language model (VLM) that can generate tokenized representations of image or video data, e.g., in response to a text input or that can generate tokenized representations of text, e.g., in response to an image input; an audio model that can input or generate tokenized representations of audio data; or a multimodal model that can that can generate output token sequences representing text data, image data or audio data, e.g., in response to inputs characterizing input text, input images input audio; and so on.

Generally, prior to the training of the generative neural network 102 by the system 100, the generative neural network 102 can have already been trained across one or more previous training stages.

For example, the one or more previous training stages can include a pre-training stage. During the pre-training stage, the generative neural network 102 can have been trained by the system 100 or a separate system on a next token prediction task, e.g., a task that requires predicting, given a current sequence of tokens, the next token that follows the current sequence in the training data.

As a particular example, the generative neural network 102 can have been trained on a maximum-likelihood objective on a large dataset of text in one or more natural languages, e.g., text that is publicly available from the Internet or another text corpus, a large dataset of computer code in one or more programming languages, e.g., Python, C++, C#, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

As another example, the one or more previous training stages can include one or more additional training stages, e.g., that occur after the pre-training stage. For example, the one or more previous training stages can include any one or more of: a supervised fine-tuning stage, a reinforcement learning stage, a preference learning stage, an instruction tuning stage, and so on.

In particular, the training system 100 can efficiently fine-tune or align the generative neural network 102 to generate more preferable outputs for the machine learning task using the training data 104. When the generative neural network 102 is a large generative neural network, such as a large language model or a vision-language model with hundreds of millions or billions of parameters, the generative neural network 102 can have a computational capability to accurately model human preferences for the machine learning task and to generating high quality (e.g., more preferable) outputs for the machine learning task. While the one or more previous training stages of the generative neural network 102 can enable the model to process inputs and generate outputs for the machine learning task, the model 102 often requires additional fine-tuning to correctly model preferences regarding which outputs for the machine learning task would be preferred by users. That is, while the pre-training may train the model to generate generally coherent outputs in response to any given input, without further training, the outputs generated by the model may not align with specific preferences or requirements for the particular machine learning task. By fine-tuning the generative neural network 102 using training data 104 that includes feedback (e.g., human feedback or feedback generated by another model) for example outputs for the machine learning task, the training system 100 can specifically fine-tune the model 102 to produce more preferable outputs for the machine learning task.

Example machine learning tasks and example architectures for the generative neural network 102 are described in more detail later in this specification.

The training data 104 for the machine learning task can include a plurality of training examples 106 for the machine learning task. Each of the training examples 106 can include (i) a first training data item, (ii) a second training data item, (iii) a training prompt, and (iv) a preference score 122 indicating a degree to which the first training data item is preferred over the second training data item as a response to the training prompt. That is, unlike other approaches that use a “hard” preference in which the training examples indicate only that the first training data item is preferred to the second training data item, this specification describes techniques for using “soft” preference scores which are non-binary, i.e., not only equal to zero or one, to represent soft preferences between training data items.

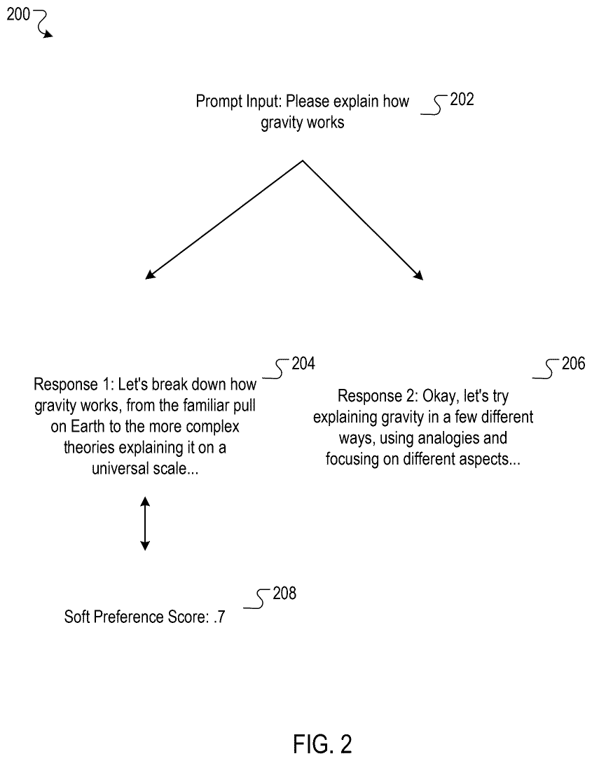

In general, the system 100 can receive the preference scores for the training examples from any of a variety of sources, e.g., from a user, from another system, as an output from a trained model, and so on. Examples of how the preference scores can be obtained are described below with reference to FIG. 2.

The update system 110 can train the generative neural network 102 by generating model updates 114, i.e., updates to the parameters of the generative neural network 102, for the generative neural network 102 based on the soft preference scores 112 for the training examples 106 and output likelihoods 116 of the example data items for the training examples 106 determined by processing the example prompts for the training examples 106 using the generative neural network 102.

In some implementations, the system makes use of a reference generative neural network 118 during the training of the target generative neural network 102. The reference generative neural network can have any appropriate architecture for processing the example prompts to generate data items for the machine learning task. In some implementations, the reference generative neural network can have the same network architecture as the target generative neural network 102. In other implementations, the reference generative neural network can have a different network architecture from the target generative neural network 102.

As a particular example, when the target generative neural network 102 is pretrained (e.g., prior to training to perform the machine learning task by the training system 100), the reference generative neural network can be an instance of the pretrained generative neural network 102 (e.g., instance of the generative neural network 102 with model parameters fixed to be the initial, pretrained model parameters of the model 102).

In these implementations, the update system 110 can determine the model updates 114 based on reference likelihoods 120 of the example data items for the training examples 106 generated using the reference neural network 118.

By training the generative neural network 102 using the reference neural network 118, the training system 100 can train the neural network 102 to better perform the machine learning task without losing pre-trained capabilities of the reference neural network 118.

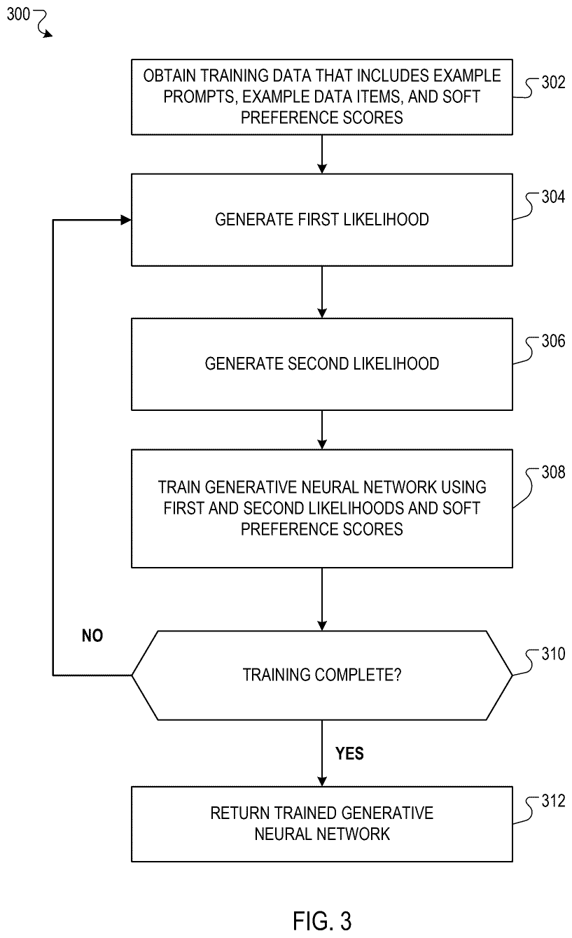

Training the generative neural network 102 using the soft preference scores 112 will be described in more detail below with reference to FIGS. 2 and 3.

After training by the training system 100, the generative neural network 102 can be used to perform the machine learning task by receiving and processing input prompts for the task (e.g., from a user, another system, etc.) to generate output data items for the task.

Example machine learning tasks and example architectures for the generative neural network 102 are described below.

In some implementations, the machine learning task can include processing an input prompt to generate an output data item. The input prompt and the output data item can include any of a variety of modalities of data, e.g., text data, image data, audio data, structured numerical data, and so on. In some implementations, the input prompt and/or the output data item can include multi-modal data, e.g., data for multiple different modalities. The quality scores for the output data items can characterize a quality or a perceived quality of the output data items. For example, the quality scores for the data items can characterize, e.g., perceptual scores for the data items, human feedback regarding the data items, and so on. As another example, the output data items can be used as part of performing a downstream task and the quality scores for the data items can be performance metrics for the downstream task as attained using the output data items.

In some implementations, the machine learning task can be a reinforcement learning task that involves controlling an agent to perform one or more agent tasks while interacting with an environment. In the context of reinforcement learning, the generative neural network 102 can be considered to be a policy for the agent, the prompts for the machine learning task can include observations of an environment of an agent and the output data items for the machine learning task can characterize actions for the agent to perform the agent's tasks. The quality scores for the output data items can be rewards associated with performance of the agent tasks by the agent.

As described above with reference to FIG. 1, the generative neural network 102 can be a language model or vision language model neural network. In general, a (vision) language model neural network can be a neural network that has been trained so that, given a text prompt that includes a sequence of tokens in a natural language, the neural network can generate the next token in the sequence. This process can be repeated to extend the text prompt one token at a time to generate a natural language output, i.e., to generate the natural language output auto-regressively token by token. At each time “time step,” the language model neural network processes the current sequence to generate a probability distribution over a vocabulary of tokens. The next token can then be selected using the probability distribution, e.g., by sampling from the distribution using nucleus sampling or another sampling technique or by selecting the highest-probability token. The tokens in the vocabulary can include any of a variety of tokens, e.g., some combination of words, sub-words, characters, punctuation and other symbols, and numbers. In general, the language model neural network is trained on a corpus of text made up of tokens from the vocabulary (and optionally other tokens that can be mapped to a designated out-of-vocabulary token), to predict the next token in a sequence of tokens from the training data. The (vision) language model neural network can be an autoregressive Transformer neural network.

A (vision) language model neural network can be made to perform a particular task by providing a natural language description of the desired response as an input or “prompt” (input sequence). In some cases, the prompt can be a few-shot prompt where a few, e.g., 1 to 10, examples of a query and an example output are provided in the text prior to the actual query.

A (vision) language model neural network can be “fine-tuned” to perform a particular task, by obtaining a pre-trained language model neural network trained on a large corpus of examples as previously described and then further training part or all of the language model neural network on a relatively small number of examples particular to the type of task that is to be performed.

The generative neural network 102 can be a large language model neural network, e.g., one that has greater than 1 billion, 10 billion or 100 billion trained parameters. The generative neural network 102 can have been trained on greater than 10 billion, 100 billion or 1000 billion words or tokens representing words or other tokens.

The model inputs and the model outputs can be sequences of elements referred to herein as tokens. A “token” as used in this specification is a vector of numerical values having a specified dimensionality, i.e., the number of numerical values is constant across different tokens. Each token can include a respective predetermined or learned embedding (an ordered collection of numerical values having a pre-determined dimensionality.

In some implementations, the model inputs and the model outputs can include tokens representing text, e.g., words, wordpieces or characters, in a natural or computer language. For example, text can be received, e.g., as a series of encoded characters, e.g., UTF-8 encoded characters; such “characters” can include Chinese and other similar characters, as well as logograms, syllabograms and the like. A text encoder, i.e., a tokenizer, can process a sequence of text to represent the text as a series of text tokens from a vocabulary of text tokens, e.g., that each represent words, wordpieces or characters in a natural or computer language. The computer language can be any formal language used to communicate with a computer, e.g., a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens can be converted into audio data that represent speech corresponding to the text.

In some implementations, the model inputs and the model outputs can include image tokens representing images. Each image token can include a block encoding of values of the pixels in a different region of an image that maps a set of values of the pixels to a respective image token. The block encoding can be obtained using a neural network such as a Transformer neural network.

As used herein an image can be any still or moving image, i.e., the image can be part of a video, in 2D or 3D, and can be a monochrome, color or hyperspectral image, i.e., including monochrome or color pixels. As defined herein an “image” includes a point cloud, e.g., from a LIDAR system, and a “pixel” includes a point of the point cloud. An image can be captured by a camera or other image sensor from the real world; and objects in the image can include physical objects, represented by the image.

In some implementations, the model inputs and the model outputs can include tokens representing audio waveforms. For example, a set (sequence) of input or output tokens can represent audio data representing a waveform e.g., instantaneous audio amplitude values or time-frequency audio data. Each audio token can include a block encoding of the audio waveform in a different time segment of the audio that maps a set of values representing the audio waveform to a respective audio token. The block encoding can be obtained using a neural network such as a Transformer neural network.

In a multimodal system audio data or an image can be flagged by a start-of-audio token or start-of-image token.

In some implementations the model inputs can include tokens representing text, pixels of an image, or an audio waveform and the generative neural network 102 can generate the output sequence of tokens to perform tasks represented by the input sequence of tokens.

In some implementations the machine learning task can include an image or audio generation task. The input sequences of tokens can then characterize images or audio to be generated, and the output sequences of tokens can include tokens defining images or audio waveforms characterized by the input sequences of tokens, e.g., text tokens.

In some implementations the machine learning task can include an image or audio processing task. The input sequences of tokens can define image or audio inputs, and the output sequences of tokens can include tokens defining text that describes the image or audio inputs. As some examples, the machine learning task can include a speech recognition task, an object or action detection task, a classification task, a captioning task, a question-answering task, or a character or word recognition task.

In some implementations the machine learning task can include a multimodal processing task in which the input sequences of tokens and/or the output sequences of tokens can include multimodal data. For example, an input sequence of tokens can characterize both an image or audio input and a text input and a corresponding output sequence of tokens can include tokens defining a result of an image or audio processing task defined by the text, such as an open vocabulary classification or object detection task.

In general, multimodal data includes a combination of two or more different types of data, e.g., two or more of audio data, image data, text data, or graph data. As one example the multimodal data can include audio-visual data, comprising a combination of pixels of an image or of video and audio data representing values of a digitized audio waveform. As another example the multimodal data can include a combination of i) text data representing text in a natural language and ii) pixels of an image or of video or audio data representing values of an audio waveform.

Some examples of multimodal tasks include: open-vocabulary image classification (the output can classify the image input based on a text input comprising text descriptions of one or more classes in the image); open-vocabulary object detection (the output can detect one or more objects in the image input based on a text input comprising text descriptions of the one or more objects); image captioning (the output can comprise text that describes the image input); text-based image search (the output can identify from amongst multiple images in the image input one or more images that meet a text description of images to be retrieved, the text description being provided in a text input); image-based retrieval (the output can identify from amongst multiple images in the image input one or more images that match a further image in the image input), and so on. The multimodal processing tasks to be performed can be defined by text in the input sequences.

In some implementations the machine learning task can include an agent control task in which the agent interacts with an environment to perform the task. The agent can be a mechanical agent such as a robot or (semi-)autonomous vehicle, interacting with a real-world environment to perform the task. The generative neural network 102 can be trained to control a simulated version of the agent in a simulated version of the environment and then afterwards used to control the real agent in the real-world environment. The input sequence of tokens can include tokens that represent an observation of the environment, e.g., an image captured by a camera or other imaging device from a real-world environment. The output sequences of tokens comprises tokens that define one or more actions to be performed by the agent in the environment in response to the observation.

In some implementations the generative neural network 102 can be stored on a user computing device, i.e., a device local to the user, such as a mobile device, e.g., a mobile phone, or a smart speaker.

In some implementations the generative neural network 102 can be implemented on a remote server in communication with a user computing device over a wired or wireless network communications link between the user computing device and the server.

The user computing device can be provided with an input mechanism, such as a text or voice interface, that enables user input from the user in a natural language. The user computing device can be provided with an output mechanism that provides a system output for the user in the same or another natural language, e.g., as speech or text; or in some other way, e.g., by displaying an image. The input and output mechanisms can include, e.g., a keyboard, microphone, speaker, display, and/or camera.

As an example, the input mechanism can include a system configured to input audio data characterizing a speech waveform of speech representing the input from the user in a natural language, and a system configured to convert the audio data into tokens representing the speech in the natural language, e.g., representing a transcription of the spoken input. The output mechanism can include a system configured to receive tokens representing the output for the user in the or another natural language and a system configured to convert the received tokens into audio data representing a waveform of speech representing the output to the user in the natural language, i.e., representing spoken words.

As a further example, the generative neural network 102 can be deployed in an environment that enables a user to provide a request for the system, e.g., to process a multimodal input to generate a corresponding output sequence output. Users can provide requests, e.g., by way of a user interface or through an application programming interface (API). The request can be transmitted from a user device, e.g., over a data communications network such as the internet, to one or more computers implementing the system, e.g., in a data center. The system can generate an output sequence and then transmit the output sequence to a user device over a data communications network.

A user computing device can be provided, as an interface for the generative neural network 102, with an input mechanism that enables user input from the user in a natural language and an output mechanism that provides a system output to the user in the natural language. The input and output mechanism can include, e.g., a keyboard and display. Also or instead the input and output mechanism can include a speech-based mechanism. For example, the input mechanism can include a system configured to input audio data characterizing a speech waveform of speech representing the input from the user in the natural language and configured to convert the audio data into tokens representing the speech in the natural language, e.g., representing a transcription of the spoken input. The output mechanism can include a system configured to receive tokens representing the output to the user in the natural language and a system configured to convert the received tokens into audio data representing a waveform of speech representing the output to the user in the natural language, i.e., representing spoken words.

In some implementations the input sequences include one or more natural language statements relating to an environment, in particular a real-world environment, and include natural language requests relating to the environment. Similarly the output sequences can include natural language replies or natural language output statements that also relate to the environment, i.e., providing information relating to the environment, in some implementations relating to or specifying actions to be taken in the environment.

The generative neural network 102 can be used for diagnosing faults, or for correcting undesired behavior, in a mechanical or computing system operating in the real world environment. The model inputs can include descriptions and/or images of observations of the mechanical or computing system, e.g., of operation of the system, optionally obtained from one or more sensors sensing a condition or operation of the system. An image observation can be converted into a text description, e.g., using an image captioning system or in other ways. The generated output sequences may include images, audio, or text that identify (describe) likely causes of the faults or undesired behavior. This can be used to repair the faults or correct the behavior. The preference measures for the machine learning task can define relatively more useful types of output for repairing faults or correcting behavior, and other aspects of the responses as previously described.

The generative neural network 102 can be used for controlling a mechanical agent such as a robot or vehicle. For example, the model inputs can include descriptions of tasks to be performed, and the generated output sequences can include lists of sub-tasks to be performed by the mechanical agent (trained to perform such sub-tasks), in order to perform the tasks. The preference measures for the machine learning task can define relatively more preferable or useful types of sub-task, task safety, efficiency, and so on.

As another example, the environment can be a computer security monitoring environment, e.g., the system can be deployed as part of a system that monitors the security of one or more computers. For example, the environment can be a computer network security monitoring environment, and the system can be deployed as part of a system that monitors the security of one or more computers on a computer network, e.g., a wireless network, a cellular network, a local area network and/or the internet. As another example, the environment can alternatively or additionally be a computer system security monitoring environment and the system can be deployed as part of a system that monitors the system for the presence of computer viruses and/or an unresolved software vulnerability, e.g., a zero-day exploit. A software vulnerability can be resolved by updating the software (e.g., patching) and/or removing (e.g., uninstalling) the software from the computer system. In these examples, the natural language requests can query whether computer security incidents have been resolved (e.g., “has the incident been resolved?”) and the model inputs can include relevant statements from system logs, i.e., that are potentially relevant to the events being queried. A computer security incident can be, e.g., a data breach, an unauthorized log-in or other access of a secured system, a detection of a computer virus or detection of a software vulnerability. An incident can be “resolved” when the underlying incident is no longer a threat to the security of the computer system e.g., the computer virus has been removed, the access to the secured system has been removed, the data breach has been mitigated, or the software having the vulnerability has been updated or removed. The system can use the model inputs 204 to generate replies to the requests that include natural language statements indicating whether the incidents have been resolved, optionally displaying evidence used to determine this.

The model inputs can include one or more of: code snippets from the software code, system logs, program logs, or other artifacts that should be left on the computer by running the program, or verification rules that represent requirements for the execution of the software program, or natural language statements describing the computer system on which the software executes. In general, the model inputs can include relevant statements, i.e., statements that are potentially relevant to the events being queried.

In some implementations obtaining input data from the environment can include obtaining, from the system logs, the data characterizing the computer network, or both, or from other data as described above, one or more observations of the computer network (which here includes computers on the network), and processing the one or more observations to generate a natural language representation of the one or more observations. The natural language requests can relate to the computer security incidents or to the secure operation of the computer network. The machine learning task can include using the natural language representations of the one or more observations to provide one or more of the natural language statements describing the computer network, and using the natural language replies or the natural language output statements to identify a security status of the computer network or a security flaw in the computer network.

As another example, the environment can be a software testing or evaluation environment, e.g., the system can be deployed as part of a system that tests software before deployment or that evaluates already-deployed software to identify bugs. In these examples, when the system tests software before deployment, the natural language requests can ask whether the software will execute as intended, and the model inputs can include code snippets from the software code and, optionally, natural language statements describing the computer system on which the software will execute. The generative neural network 102 can process the model inputs to generate replies that indicate whether the code will execute as intended, optionally displaying evidence used to determine this. When the system monitors the execution of code after deployment, the natural language requests can ask whether a software program, or a portion of a software program, has executed as intended, and the model inputs can include one or more of: code snippets from the software code, system logs, program logs, or other artifacts that should be left on the computer by running the program, or verification rules that represent requirements for the execution of the software program, or natural language statements describing the computer system on which the software executes. The model 102 can then process the model inputs to generate replies that indicate whether the code has executed as intended, optionally displaying evidence used to determine this. As a particular example, the software program can be part of the boot up of a computer, and the model 102 can generate a reply each time that the computer starts up to verify whether the computer will function correctly after start up.

As another example, the environment can be an educational environment, e.g., the system can be deployed as part of an education software program that assists a user in learning or practicing one or more corresponding skills. In these examples, the model inputs can include natural language statements describing or referencing a scenario or scene in a real-world or imagined environment, and the requests can be questions about the scenario or scene.

As another example, the environment can be an information retrieval environment, e.g., the system can be deployed as part of a search engine or other software that allows a user to search for information in a corpus of documents, e.g., the Internet or another electronic document corpus. In these examples, the requests can be any appropriate natural language question, and the replies can optionally include evidence such as include relevant statements from the corpus of documents, e.g., as identified by searching the corpus using conventional information retrieval techniques.

In some implementations, the generative neural network 102 is a visual language model (VLM). In general, the VLM can process input sequences that include tokens that each represent natural language or (a part of) an image or video to generate output tokens that each represent natural language or (a part of) an image or video. For example, the VLM can be configured to describe an image or video using natural language, e.g., to perform an image or video captioning task. As another example, the VLM can be configured to process input tokens representing an image and text tokens representing a query about the image or a request to modifying the image, and to generate output tokens representing an answer to the query or representing a version of the image that has been modified in accordance with the request. The VLM can generate output tokens representing an image or video that is generated in response to input tokens providing a visual and/or audio and/or textual description of a desired image or video.

In some implementations, the “language” of the language model is not a natural language such (e.g., English), but can instead be a text-based encoding describing an entity or class of entities, e.g., a chemical or biological entity, such as a chemical structure or molecule. For example, the text-based encoding can be a sequence of tokens that defines a molecule or protein, e.g., a sequence specifying an arrangement of atoms or chemical functional groups in a molecule, or the amino acid residues of a protein. The language model can be referred to as a chemical and/or biological language model in such cases. The model inputs therefore can be input strings defining chemical (e.g., protein) structures and the model outputs can include output strings defining different chemical structures from the input strings. The strings can be in the Simplified Molecular Input Line Entry System, SMILES, format, for example.

In another example of a computer language text generation task, a model input can include an image or video and a sequence of text in a computer language for performing a task in relation to the image or video, e.g., a data processing task that involves analyzing the content of the image or video to provide a result of the analysis or, e.g., a search to search for information relating to the content of the image or video. The computer language in the model output can include computer language for invoking a function or calling one or more external APIs. Merely as one example, such an output can be formatted as a JSON object. As previously, the sequence of text in a multimodal input can define the task to be performed and the second modality input can include, e.g., an image or video in relation to which the task is to be performed, e.g., a task that involves manipulation of particular types of data that may benefit from access to an API such as mathematical data, date/time related data, scientific data, recent data that may post-date training of the model (that can be accessed by a search function or API), and so on. After training, when the model is used in inference, the model output can include text in the or another computer language for performing a task, e.g., as described above, in relation to an image or video in the second modality input. The machine learning task can then include using the text in the computer language to perform the task.

In some implementations, the generative neural network 102 can be used to interact with a human user of a digital assistant such as a smart speaker, smart display, or other device. For example, information defining a task can be obtained from the digital assistant, and the digital assistant can be used to instruct the user to perform the task. For example, this can include receiving, at the digital assistant, a request from the user for assistance and determining, in response to the request, a series of tasks for the user to perform, e.g., steps or sub-tasks of an overall task. Then for one or more tasks of the series of tasks, e.g., for each task, e.g., until a final task of the series the digital assistant can be used to output to the user an indication of the task, e.g., step or sub-task, to be performed. This can be done using natural language, e.g., on a display and/or using a speech synthesis subsystem of the digital assistant. Visual, e.g., video, and/or audio observations of the user performing the task can be captured, e.g., using the digital assistant. A system can then be used to determine whether the user has successfully achieved the task, e.g., step or sub-task, i.e., from the answer as previously described. If there are further tasks to be completed the digital assistant can then, in response, progress to the next task (if any) of the series of tasks, e.g., by outputting an indication of the next task to be performed. In this way users can be led step-by-step through a series of tasks to perform an overall task.

As an illustrative example, a user can be interacting with a digital assistant and ask for help performing an overall task consisting of multiple steps, e.g., cooking a pasta dish. While the user performs the task, the digital assistant receives audio and/or video inputs representative of the user's progress on the task, e.g., images or video or sound clips of the user cooking. The digital assistant uses model 102 as described above, in particular by providing it with the captured audio and/or video and a question that asks whether the user has completed a particular step, e.g., ‘Has the user finished chopping the peppers?’, to determine whether the user has successfully completed the step. If the answer confirms that the user has successfully completed the step then the digital assistant progresses to telling the user to perform the next step or, if at the end of the task, or if the overall task is a single-step task, then the digital assistant may indicate this to the user. The digital assistant can then stop receiving or processing audio and/or video inputs to ensure privacy and/or reduce power use.

The digital assistant can also include a user interface to enable a user to request assistance and to output information. In implementations this is a natural language user interface and can include a keyboard, voice input-output subsystem, and/or a display. The digital assistant can further include an assistance subsystem configured to determine, in response to the request, a series of tasks for the user to perform. In implementations this can include a generative (large) language model, in particular for dialog. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g., of a series of tasks, e.g., until a final task of the series. More particularly, the assistance control subsystem and output to the user an indication of the task to be performed, capture, using the observation capture subsystem, visual or audio observations of the user performing the task, determine from the above-described answer whether the user has successfully achieved the task. In response, the digital assistant can progress to a next task of the series of tasks and/or control the digital assistant, e.g., to stop capturing observations.

In some implementations, a particular task that is to be performed by the generative neural network 102 can be described by part or all of a sequence of text in an input to the model 102. For example, in a model input that includes an image such a prompt can specify, e.g., “Generate a caption”, “Generate a description”, “Answer the following question: [about the image or video]”, or “Detect a person”. Where the model 102 is used for an agent control task a prompt can define, e.g., “Take the knife out of the drawer”, or “Q: What action should the robot take to take the knife out of the drawer?”. Also or instead such a prompt can give one or more examples of a task to be performed. The model 102 can be trained on multiple natural and/or computer languages and the prompt may then specify a language to use.

A few further examples of some machine learning tasks that can be performed by a generative neural network 102 trained as described herein follow. The tasks described below can include tasks that require spatial awareness or other context from input images or video. For example, a prompt may ask “What is the object in the top left corner?”.

In general, for the tasks below the model 102 can have been trained or fine-tuned on examples of the input and output for the task. For example, the model 102 can have been trained using still or moving images containing one or more objects or actions, and corresponding sequences of text or other data e.g., describing or classifying the images. However large, “foundation” models can, in general, perform some tasks zero-shot, i.e., without having been specifically trained on those tasks.

As one example the task can include an object or action detection task. For example, a generated output sequence can include or represent text that describes or otherwise labels detected object(s) or action(s) in an input that includes an image or audio, and can include coordinates such as bounding-box coordinates for the detected object(s) or action(s), e.g., “10 20 90 100 cat 20 30 100 100 dog”.

As another example the task can include a classification task, e.g., an object or action classification task. A generated output sequence can include data, e.g., text, that classifies the object(s) or action(s) in represented in conditioning data, e.g., in an image or audio, into one of a plurality of classes, or that otherwise classify object(s) or action(s) represented in the conditioning data.

As another example the task can include a still or moving image describing task, e.g., a captioning task (which, as used here, includes an audio description task to explain what is happening in an image). A generated output sequence can include data, e.g., text, describing an input image or video. For example, a generated output sequence can provide a caption or description or it can count objects in the image or video, or it can provide some other form of description.

As another example the task can include a still or moving image question-answering task. A generated output sequence can include data, e.g., text, that answers a question about an input, e.g., an input image or audio, where the question is also specified in the input, e.g., as sequence of text. This may be used, e.g., to answer questions about visual plots and charts or about sounds.

As another example the task can include a character or word recognition task, e.g., an OCR (optical character recognition) task. An input can include a still or moving image and a generated output sequence can include text that represents characters or words in the input, e.g., in a natural language.

As another example the task can include a still or moving image generation task. A generated output sequence can include image data defining values for pixels of a still or moving image, and an input, e.g., a sequence of text, may describe or characterize the image to be generated. Merely as an example, an image of a plot or chart can be generated to represent the input, e.g., comprising text.

As another example the task can include a computer language text generation task. An input can include a natural language description of a task to be performed, and optionally an image (if the task is to be performed on or in relation to an image), and a generated output sequence can include text in a computer language to perform the task, e.g., a task of analyzing the content of the image to provide a result of the analysis or to search for information relating to the content of the image.

As a particular example the computer language in a generated output sequence can include computer language for invoking a function or calling one or more external APIs. Merely as one example, such an output sequence can include data formatted as a JSON object. As previously, an input can define a task to be performed and can also include an image in relation to which the task is to be performed. In general the task can involve manipulation of particular types of data that can benefit from access to an API such as mathematical data, date/time related data, scientific data, recent data that may post-date training of the model 102 (that can be accessed by a search function or API), and so on; and the generated output sequence can include text in a computer language for performing the task. The machine learning task can include using the text in the computer language to perform the task.

In general where a generated output sequence includes text, such text can be converted to speech representing the text, and an audio (speech) output provided.

In some implementations the task can include an agent control task in which the agent interacts with an environment to perform the agent control task. In these implementations an input can include an observation characterizing the environment. For example, an input can include a sequence of text that defines a task to be performed by the agent and an image representing an observation of the environment, e.g., captured by a camera or other imaging device from a real-world environment. A generated output sequence can include an action selection output, e.g., including text, that is used to select one or more actions to be performed by the agent in the environment in response to the observation. As an illustration the generated output sequence can define an action as text such as “A: 132 114 128 5 25 156”, that can be converted into a control signal for a mechanical agent, such as a robot, e.g., “ΔT=[0.1, −0.2, 0] ΔR=[10°, 25°, −7°]”. The action selection output can also or instead define one or more low-level skills, e.g., from a vocabulary of previously learnt skills. As before, a sequence of text in a model input can describe the task to be performed, e.g., “What action should the robot take to [perform task]”. Examples of systems for controlling an agent that can be fine tuned as described herein can include PaLM-E (Driess, et al., arXiv:2303.03378), RT-1 (Brohan, et al., arXiv:2212.06817), and RT-2 (Brohan, et al., arXiv:2307.15818).

In some agent control implementations, the environment is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent can be a robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations can include, e.g., one or more of: images, object position data, and sensor data to capture observations as the agent interacts with the environment. The actions can define control signals to control the robot or other mechanical agent, e.g., positions, torques, or other control signals for the parts of the mechanical agent, or higher-level control commands.

In some agent control implementations the agent can be a human agent and the environment can be a real-world environment. For example, the agent can be a human user of a digital assistant such as a smart speaker, smart display, or some other device that is used to instruct the user to perform actions. The task can include any real-world task that the user wishes to perform. The observations can be obtained from an observation capture subsystem, e.g., a monitoring system such as a video camera or sound capture system, to capture visual observations of the user performing the task. The actions can include instructions in the form of, e.g., text, image, video, or audio data such as speech, that guide the user in performing the task.

The described systems and techniques can be applied to a wide range of different types of input sequences and output sequences. In implementations of the described techniques the tokens can represent, characterize, or encode any type of information in a sequence, e.g., stream of data. The term “represent” is used, below, generally to refer to any way in which a token can encode part of a sequence. The tokens may include marker tokens, such as a start of sequence token, an end of sequence token, and a separator token (indicating a separation or break between two distinct parts of a sequence). The tokens may, but need not be, drawn from a defined vocabulary of tokens.

Some of these implementations can be used for natural language tasks such as providing a natural language response to a natural language input, e.g., for question answering, or for text completion. In some implementations the input sequence can represent text in a natural language and the output sequence may represent text in the same natural language, e.g., a longer item of text. For example, in some implementations the input sequence can represent text in a natural language and the output sequence may represent the same text with a missing portion of the text added or filled in. For example, the output sequence can represent a predicted completion of text represented by the input sequence. Such an application can be used, e.g., to provide an auto-completion function, e.g., for natural language-based search. In some implementations the input sequence can represent a text in a natural language, e.g., posing a question or defining a topic, and the output sequence can represent a text in a natural language which is a response to the question or about the specified topic.

As another example the input sequence can represent a first item of text and the output sequence can represent a second, shorter item of text, e.g., the second item of text can be a summary of a passage that is the first item of text. As another example the input sequence can represent a first item of text and the output sequence can represent an aspect of the first item of text, e.g., it can represent an entailment task, a paraphrase task, a textual similarity task, a sentiment analysis task, a sentence completion task, a grammaticality task, and in general any natural language understanding task that operates on a sequence of text in some natural language, e.g., to generate an output that classifies or predicts some property of the text. For example, some implementations can be used to identify a natural language of the first item of text, or of spoken words where the input is audio (as described below).

Some implementations can be used to perform neural machine translation. Thus in some implementations the input tokens can represent words, wordpieces, or characters in a first natural language and the output tokens can represent words, wordpieces or characters in a second, different natural language. That is, the input sequence can represent input text in the first language and the output sequence can represent a translation of the input text into the second language.

Some implementations can be used for automatic code generation. For example, the input tokens can represent words, wordpieces or characters in a first natural language and the output tokens can represent instructions in a computer programming or markup language, or instructions for controlling an application program to perform a task, e.g., build a data item such as an image or web page.

Some implementations can be used for speech recognition. In such applications the input sequence can represent spoken words and the output sequence can represent a conversion of the spoken words to a machine-written representation, e.g., text. Then the input tokens can include tokens representing an audio data input including the spoken words, e.g., characterizing a waveform of the audio in the time domain or in the time-frequency domain. The output tokens can represent words, wordpieces, characters, or graphemes of a machine-written, e.g., text, representation of the spoken input, that is representing a transcription of the spoken input.

Some implementations can be used for handwriting recognition. In such applications the input sequence can represent handwritten words, syllabograms or characters and the output sequence may represent a conversion of the input sequence to a machine-written representation, e.g., text. Then the input tokens can include tokens representing portions of the handwriting and the output tokens can represent words, wordpieces, characters or graphemes of a machine-written, e.g., text, representation of the spoken input.

Some implementations can be used for text-to-speech conversion. In such applications the input sequence can represent text and the output sequence can represent a conversion of the text to spoken words. Then the input tokens can include tokens representing words or wordpieces or graphemes of the text and the output tokens can represent portions of audio data for generating speech corresponding to the text, e.g., tokens characterizing a portion of a waveform of the speech in the time domain or in the time-frequency domain, or phonemes.

Some implementations can be used for a genomics task, where the input sequence represents a fragment of a DNA sequence or other molecule sequence and the output sequence is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the model 102 can be configured to perform multiple different individual machine learning tasks, e.g., two or more of the machine learning tasks mentioned above. For example, the model 102 can be configured to perform multiple individual natural language understanding tasks, with the model inputs including an identifier for the individual natural language understanding task to be performed on the model inputs.

In some implementations the input sequence and the output sequence represent different modalities of input. For example, the input sequence can represent text in a natural language and the output sequence can represent an image or video corresponding to the text; or vice-versa. In general, the tokens can represent image or video features and a sequence of such tokens can represent an image or video. There are many ways to represent an image (or video) using tokens. As one example an image (or video) can be represented as a sequence of regions of interest (RoIs) in the image, optionally including one or more tokens for global image features. For example, an image can be encoded using a neural network to extract RoI features; optionally (but not essentially) a token can also include data, e.g., a position encoding, representing a position of the RoI in the image. As another example, the tokens can encode color or intensity values for pixels of an image. As another example, some image processing neural network systems, e.g., autoregressive systems, naturally represent images as sequences of image features. As another example, a transformer-based sequence processing neural network system as previously described can be used to process images instead of or as well as text (e.g., if trained on images instead of or as well as text).

Thus in some implementations at least one of the input sequence and the output sequence is a sequence representing an image or video and can include tokens representing the image or video. For example, the input sequence can be a sequence of text, the input tokens can represent words, wordpieces, or characters and the output sequence can include output tokens representing an image or video, e.g., described by the text, or providing a visual answer to a question posed by the text, or providing a visualization of a topic of the text. In another example the input sequence can include a sequence of input tokens representing an image or video, and the output tokens can represent words or wordpieces, or characters representing text, e.g., for a description or characterization of the image or video, or providing an answer to a question posed visually by the image or video, or providing information on a topic of a topic of the image or video.

In some other implementations both the input sequence and the output sequence can represent an image or video, and both the input tokens and the output tokens can represent a respective image or video. In such implementations the method/system can be configured to perform an image or video transformation. For example, the input sequence and the output sequence can represent the same image or video in different styles, e.g., one as an image the other as a sketch of the image; or different styles for the same item of clothing.

In some implementations the input sequence represents data to be compressed, e.g., image data, text data, audio data, or any other type of data; and the output sequence represents a compressed version of the data. The input and output tokens can each include any representation of the data to be compressed/compressed data, e.g., symbols or embeddings generated/decoded by a respective neural network.

In some implementations the input sequence represents a sequence of actions to be performed by an agent, e.g., a mechanical agent in a real-world environment implementing the actions to perform a mechanical task. The output sequence can include a modified sequence of actions, e.g., one in which an operating parameter, such as a speed of motion or power consumption, has a limited value; or one in which safety or other boundary is less likely to be crossed. Then both the input tokens and the output tokens may represent the actions to be performed.

In some implementations the input sequence represents a sequence of health data and the output sequence can include a sequence of predicted treatment. Then the input tokens can represent any aspect of the health of a patient, e.g., data from blood and other medical tests on the patient and/or EHR (Electronic Health Record) data; and the output tokens can represent diagnostic information, e.g., relating to a disease status of the patient and/or relating to suggested treatments for the patient, and/or relating to a likelihood of an adverse health event for the patient.

As a particular example the model 102 can be a multimodal model neural network in which one or both of the model input (i.e., input sequence) and the model output (i.e., output sequence) include an image or audio. For example the multimodal machine learning model can be configured to process an input sequence including visual tokens representing pixels of a still or moving image (which here may include a point cloud image), and/or data representing an audio waveform, e.g., values or features of the audio waveform such as audio tokens, and/or text tokens representing a sequence of text, to generate an output sequence, e.g., including text tokens representing the still or moving image or audio waveform, and/or a sequence of intensity value inputs for the pixels of an image or a sequence of values defining an audio waveform. A visual token can, e.g., represent multiple pixels in a region of the image, e.g., as features of the region. Such a multimodal model 102 can perform any of the previously described tasks, e.g., using a multimodal input, or by providing a multimodal output, or by converting between different input and output modes (e.g., text/image/audio). For example, it can generate text representing, describing (e.g., captioning), or otherwise characterizing an image or audio input, e.g., by answering a question related to the image or audio input, e.g., relating to a future, e.g., physical prediction of a state of objects represented by the image or audio. As another example it can generate an image or audio represented, described, or otherwise characterized by a text input, or otherwise in response to the text input, e.g., representing an image or audio answer to a text question.

FIG. 2 shows an example 200 of a training example 106 when the data items generated by the generative neural network are text.

As shown in the example 200, the training example includes a training prompt 202 (“Please explain how gravity works”), a first training data item 204 (“Let's break down how gravity works, from the familiar pull on Earth to the more complex theories explaining it on a universal scale . . . ”) that can be generated by the generative neural network from the training prompt 202, and a second, different training data item 206 (“Okay, let's try explaining gravity in a few different ways, using analogies and focusing on different aspects . . . ”) that can be generated by the generative neural network from the training prompt 202.

The training example 106 also includes a soft preference score 208 (0.7) that indicates a degree to which the first training data item 204 is preferred over the second training data item 206 as a response to the training prompt 202. For example, the soft preference score 208 can represent the probability (0.7) that a given user would prefer the first training data item 204 over the second training data item 206 as a response to the training prompt 202.

The system 100 can obtain the soft preference scores in the training examples 106 in any of a variety of ways.

For example, for one or more of the training examples 106, the preference score can be based on a user input specifying the preference score received prior to or during the training of the target generative neural network. For example, the system 100 or another system can present a user interface that displays the training prompt 202, the first training data item 204, and the second training data item 206 and that allows a user to submit an input specifying a score that indicates the degree to which the user prefers the first training data item 204 to the second training data item 206 as a response to the training prompt 202.

As another example, for one or more of the training examples 106, the preference score can have been generated by combining a plurality of initial preference scores. Each initial preference score can have been specified by a corresponding user input that indicates a preference between the first training data item and the second training data item given the training prompt. For example, the system 100 can compute the preference score 208 as an average of binary preference scores received from multiple users, where each binary preference score indicates a “hard” preference between the first training data item 204 and the second training data item 206, e.g., is equal to 1 if the user prefers the first training data item 204 and equal to 0 if the user prefers the second training data item 206.

As yet another example, for one or more of the training examples 106, the preference score can have been generated by processing an input that includes (i) the first training data item, (ii) the second training data item, and (iii) the training prompt using a preference generative neural network. For example, the preference generative neural network can be a pre-trained generative neural network and the system can include, in the input, an instruction that causes the generative neural network to generate an output that defines the soft preference score.

As yet another example, for one or more of the training examples 106, the preference score can have been generated from (i) a first likelihood generated by processing an input that includes the first training data item and the training prompt using a preference generative neural network and (ii) a second likelihood generated by processing an input that includes the first training data item and the training prompt using a preference generative neural network. In these examples, the preferences are estimated “self-preferences.”

In any of the above examples, the preference scores can be generated “off-line,” so that the first and second training data items and the preference scores are generated before training begins. Alternatively, the preference scores can be generated “on-line,” i.e., during training. In some of these “on-line” examples, the first and second training data items can be generated by the target generative neural network at each training iteration.

FIG. 3 is a flow diagram of an example process 300 for training a target generative neural network to perform a machine learning task. For convenience, the process 300 will be described as being performed by a system of one or more computers located in one or more locations. For example, a training system, e.g., the training system 100 of FIG. 1, appropriately programmed in accordance with this specification, can perform the process 300.

The system can obtain training data for the machine learning task that includes a plurality of training examples (step 302).

Each training example can include (i) a first training data item y₁, (ii) a second training data item y₂, (iii) a training prompt x, and (iv) a preference score \hat{p} indicating a degree to which the first training data item is preferred over the second training data item as a response to the training prompt.

As described above, the example prompts and the example data items can include any of a variety of modalities of data, e.g., text data, image data, audio data, structured numerical data, and so on. In some implementations, the example prompts and/or the example data items can include multi-modal data, e.g., data for multiple different modalities.

Moreover, as described above, the preference score is a “soft” preference score. In other words, the preference score is a non-binary value within a predetermined range. For example, the preference score can have a value between zero and one, exclusive. This distinguishes the training examples over those used to train with “hard” preferences, which only indicate which of the two training data items in the example is the preferred data item.

The system can train the target generative neural network over a sequence of training iterations. At each training iteration, the system can train the target generative neural network on a set of training examples corresponding to the training iteration by performing steps 304 through 308. For example, at each training iteration, the system can sample or otherwise select a mini-batch of training examples from the larger set of training data received at step 302.

As will be clear from the description below, as a result of being trained using the process 300, the neural network is optimized such that a contribution of preference data to the objective function used for optimizing the target generative neural network is determined based on the preference score associated with the preference data, i.e., the training examples.

For each training example, the system processes the training prompt in the training example using the target generative neural network to generate a first likelihood score for the first training data item in the training example (step 304). The first likelihood score can be represented as π_{θ}(y₁|x), where θ are the parameters of the target generative neural network.

For each training example, the system processes the training prompt in the training example using the target generative neural network to generate a second likelihood score for the second training data item in the training example (step 306). The second likelihood score can be represented as π_{θ}(y₂|x).

The likelihood scores can be, e.g., log likelihoods or probabilities of the corresponding training data items given the training prompt and can be determined from logits or probabilities assigned by the generative neural network when generating each token of the training data item.

The system can determine the likelihood, π_{θ}(y|x), of the target generative neural network generating an example data item y by processing an example prompt x by any of a variety of methods. For example, in some implementations, the target generative neural network can be configured to generate a model output that specifies a distribution of output data items (e.g., by specifying a mean and covariance for a distribution of output data items, by specifying logits or probabilities for a set of output data items, etc.) and the system can determine the likelihood π_{θ}(y|x) to be the likelihood of the example data item y according to a distribution of data items specified by the model output generated by the target generative neural network processing the example prompt x.

As another example, in some implementations, the target generative neural network can be configured to generate output data items for an example prompt x by sampling noise values z from a prior noise distribution, p_{z}(z), (e.g., a multi-variate Gaussian noise distribution, a multi-variate uniform noise distribution, etc.) and by then processing the sampled noise values and the example prompt to generate an output data item following a mapping defined by the target generative neural network, f_{θ}(z, x). When the target generative neural network is configured to generate output data items by transforming sampled noise, the system can determine the likelihood π_{θ}(y|x) to be a likelihood of sampling a noise value from the prior noise distribution that the target generative neural network maps to the example data item y (e.g., a likelihood of sampling a noise value z such that y=f_{θ}(z, x)). As a particular example, the target generative neural network can define an invertible transformation from noise values to data items, f_{θ}(z|x), and the system can determine π_{θ}(y|x) following:

$${π}_{θ} ( y \vert x ) = {p}_{z} ( {f}_{θ}^{- 1} ( y \vert x ) ) \vert \frac{\partial {f}_{θ}^{- 1} ( y \vert x )}{\partial y} \vert$$

Where

$${f}_{θ}^{- 1} ( y \vert x )$$

is the inverse transformation defined by the target generative neural network and

$$\vert \frac{\partial {f}_{θ}^{- 1} ( y \vert x )}{\partial y} \vert$$

is a determinant of the Jacobian matrix of

$${f}_{θ}^{- 1} ( y \vert x ) .$$

In some implementations, the target generative neural network can be configured to auto-regressively generate output data items. For example, the target generative neural network can be configured to generate a sequence of n data items, y_{1:n}, over a sequence of auto-regressive iterations. At each auto-regressive iteration, the target generative neural network can process an input prompt and some or all of the data items generated at the previous auto-regressive iterations to generate an output data item for the auto-regressive iteration. When the target generative neural network auto-regressively generates output data items, the system can determine the likelihood, π_{θ}(y_{1:n}|x), of the target generative neural network generating an example sequence of data items y_{1:n} by processing an example prompt x following:

$${π}_{θ} ( {y}_{1 : n} \vert x ) = ⋯ {π}_{θ} ( {y}_{n} \vert {y}_{n - 1} , … , {y}_{1} , x )$$

Where π_{θ}(y₁|x) is the likelihood of the target generative neural network processing the example prompt x to generate the first example data item y₁, π_{θ}(y₂|y₁, x) is the likelihood of the target generative neural network processing the example prompt x and the first example data item y₁ to generate the second example data item y₂, and so on.

In some implementations, the system can determine the likelihood, π_{θ}(y|x), by determining a log-likelihood, log π_{θ}(y|x), or any other appropriate function of the likelihood π_{θ}(y|x).

The system then trains the target generative neural network using, for each training example, the first likelihood score for the first training data item in the training example, the second likelihood score for the second training data item in the training example, and the preference score in the training example (step 308).

As a particular example, the system can train the neural network on an objective that encourages the neural network to, for each example, assign a higher likelihood to a preferred data item (winner output) y_{w} than to a non-preferred data item (loser output) yₗ given the training prompt in the training example.

However, because the preference is “soft” rather than “hard” instead of using the first training data item as the preferred data item, the objective represents the preferred data item as a sample from a first weighted geometric average of the first and second likelihoods, with the weight assigned to the first likelihood being the preference score.

Similarly, instead of using the second training data item as the non-preferred data item, the objective represents the non-preferred data item as a sample from a second weighted geometric average of the first and second likelihoods, with the weight assigned to the first likelihood being one minus the preference score.

That is, rather than using the first and second likelihoods directly, the system instead represents the likelihood score π̅_{θ}(y_{w}|x) for the preferred data item as

$${\overline{π}}_{θ} ( {y}_{w} \vert x ) = \frac{1}{{z}_{π , w} ( x )} {{π}_{θ} ( {y}_{1} \vert x )}^{\hat{p}} {{π}_{θ} ( {y}_{2} \vert x )}^{1 - \hat{p}}$$

and represents the likelihood score π̅_{θ}(yₗ|x) for the non-preferred data item as

$${\overline{π}}_{θ} ( {y}_{l} \vert x ) = \frac{1}{{z}_{π , l} ( x )} {{π}_{θ} ( {y}_{1} \vert x )}^{1 - \hat{p}} {{π}_{θ} ( {y}_{2} \vert x )}^{\hat{p}} ,$$

where Z_{π,w}(x) and Z_{π,l}(x) are respective normalization terms for the preferred and non-preferred data items. In practice, the system can set both Z_{π,w}(x) and Z_{π,l}(x) equal to one. That is, the system instead represents the likelihood score π̅_{θ}(y_{w}|x) for the preferred data item as π̅_{θ}(y_{w}|x)=π_{θ}(y₁|x)^{\hat{p}}π_{θ}(y₂|x)^{1-\hat{p}} and represents the likelihood score π̅_{θ}(yₗ|x) for the non-preferred data item as π̅_{θ}(yₗ|x)=π_{θ}(y₁|x)^{1-\hat{p}}π_{θ}(y₂|x)^{\hat{p}}.

In some implementations, the objective encourages the neural network to assign higher likelihoods as described above while penalizing the neural network for generating data items (or, more generally, likelihoods for data items) that deviate from corresponding outputs of a reference neural network. The reference neural network can be, e.g., an already-trained generative neural network or can have an exponential moving average of the parameters of the target generative neural network.

In particular, in these implementations, the system can process the training prompt using the reference generative neural network to generate a first reference likelihood score for the first training data item and process the training prompt using the reference generative neural network to generate a second reference likelihood score for the second training data item.

The system then trains the target generative neural network using, for each training example, the first likelihood score and the first reference likelihood score for the first training data item in the training example, the second likelihood score and the second reference likelihood score for the second training data item in the training example, and the preference score.

For example, in these implementations, the system can train the generative neural network using (i) a first ratio between the first likelihood score and the first reference likelihood score for the first training data item in the training example, (ii) a second ratio between the second reference likelihood score and the second likelihood score for the second training data item in the training example, and (iii) the preference score.

As a particular example of this, the objective function can include a term that measures a product of the first and second ratio and a weight for the first term that is based on the preference score.

As another particular example of this, the objective function can include a term that measures a logarithm of a difference between the first and second ratio and a weight for the first term that is based on the preference score.

More specifically, like the first and second likelihood scores, the system can represent the reference likelihood score π̅_{ref}(y_{w}|x) for the preferred data item as π̅_{ref}(y_{w}|x)=π_{ref}(y₁|x)^{\hat{p}}π_{ref}(y₂|x)^{1-\hat{p}} and represents the reference likelihood score π̅_{ref}(yₗ|x) for the non-preferred data item as π̅_{ref}(yₗ|x)=π_{ref}(y₁|x)^{1-\hat{p}}π_{ref}(y₂|x)^{\hat{p}}. As with the first and second likelihood scores, the system can optionally include respective normalization terms for the reference likelihoods.

The system can generally train the generative neural network on any appropriate preference optimization objective by replacing the likelihoods (and the reference likelihoods, when included) for the preferred and non-preferred data items in the objective with the modified likelihoods described above. Examples of preference optimization objectives include any of a variety of direct preference optimization (DPO) based objectives.

Some specific examples of objectives now follow.

As one example, the objective can be a geometric direct preference optimization (GDPO) objective represented as follows:

$${ℒ}_{GDPO} ( {π}_{θ} , {π}_{ref} ) = - {𝔼}_{𝒟} [ log σ ( β log \frac{{{π}_{θ} ( {y}_{1} \vert x )}^{\hat{p}} {{π}_{θ} ( {y}_{2} \vert x )}^{1 - \hat{p}} {{π}_{ref} ( {y}_{1} \vert x )}^{1 - \hat{p}} {{π}_{ref} ( {y}_{2} \vert x )}^{\hat{p}}}{{{π}_{ref} ( {y}_{1} \vert x )}^{\hat{p}} {{π}_{ref} ( {y}_{2} \vert x )}^{1 - \hat{p}} {{π}_{θ} ( {y}_{1} \vert x )}^{1 - \hat{p}} {{π}_{θ} ( {y}_{2} \vert x )}^{\hat{p}}} ) ] = - {𝔼}_{( x , {y}_{1} , {y}_{2} , \hat{p} ) \sim 𝒟} [ log σ ( β ( 2 \hat{p} - 1 ) log \frac{{π}_{θ} ( {y}_{1} \vert x ) {π}_{ref} ( {y}_{2} \vert x )}{{π}_{ref} ( {y}_{1} \vert x ) {π}_{θ} ( {y}_{2} \vert x )} ) ] ,$$

where D is the training data set, and β and σ are constant scalar values.

As another example, the objective can be a Geometric Identity Preference Optimization (GIPO) objective represented as follows:

$${ℒ}_{GIPO} ( {π}_{θ} , {π}_{ref} ) = {𝔼}_{( x , {y}_{1} , {y}_{2} , \hat{p} ) \sim 𝒟} [ {( 2 \hat{p} - 1 )}^{2} {( {h}_{θ} ( x , {y}_{1} , {y}_{2} ) - \frac{1}{2 β} )}^{2} ] ,$$

$$where {h}_{θ} ( x , {y}_{1} , {y}_{2} ) = {r}_{θ} ( {y}_{w} \vert x ) - {r}_{θ} ( {y}_{l} \vert x ) , and {r}_{θ} ( y \vert x ) = β log ( \frac{{\overline{π}}_{θ} ( y \vert x )}{{\overline{π}}_{ref} ( y \vert x )} ) + β log ( Z ( x ) ) ,$$

where Z(x) is a normalization term that can optionally be set equal to 1 as described above.

As yet another example, the objective can be a Geometric Robust Preference Optimization (GROPO) objective represented as follows:

$${ℒ}_{GDPO} ( {π}_{θ} , {π}_{ref} ) = α ( 1 - {𝔼}_{𝒟} [ σ ( β ( 2 \hat{p} - 1 ) log \frac{{π}_{θ} ( {y}_{1} \vert x ) {π}_{ref} ( {y}_{2} \vert x )}{{π}_{ref} ( {y}_{1} \vert x ) {π}_{θ} ( {y}_{2} \vert x )} ) ] ) + {γℒ}_{GDPO} ( {π}_{θ} , {π}_{ref} ) .$$

Generally, the generative neural network is trained by updating values of learnable parameters of the generative neural network, e.g., learnable parameters, such as weights, of the generative neural network.

The generative neural network is trained to minimize the objective. This generally involves backpropagating gradients of the objective function to update the learnable parameters using any appropriate gradient descent optimization algorithm, e.g., Adam, Adafactor, AdamW, or another optimization algorithm.

The system can determine whether training is complete (step 310). The system can use any of a variety of criteria to determine whether the training is complete. For example, the system can determine that training is complete after a pre-determined number of training iterations. As another example, the system can determine that training is complete when a value of the objective function falls below a pre-determined threshold. As another example, the system can determine that training is complete when a difference between values of the objective function for the current training iteration and a previous training iteration falls below a pre-determined threshold.

If the system determines that training is not complete, the system can continue to a next training iteration (e.g., return to step 304).

When the system determines that the training is complete, the system can return the trained target generative neural network (step 312).

In some implementations the process 300 is adapted to run on a parallel processing computer system that includes a plurality of hardware computing devices configured to operate in parallel. Each hardware computing device may comprise a neural network accelerator, i.e., specialized hardware that is used to accelerate neural network computations, such as a GPU (Graphics Processing Unit) or TPU (Tensor Processing Unit). In general a neural network accelerator is configured to perform hardware matrix multiplications; it can include a set of one or more multiply accumulate units (MACs).

In such an environment first and second respective instances of the generative neural network can be maintained on respective first and second respective hardware devices. The input prompt can then be processed using the first instance of the generative neural network on the first hardware device to generate the first likelihood score and, in parallel, the prompt can be processed using the second instance of the generative neural network on the second hardware device to generate the second likelihood. Similar parallelism can be employed to generate the first and second reference scores.

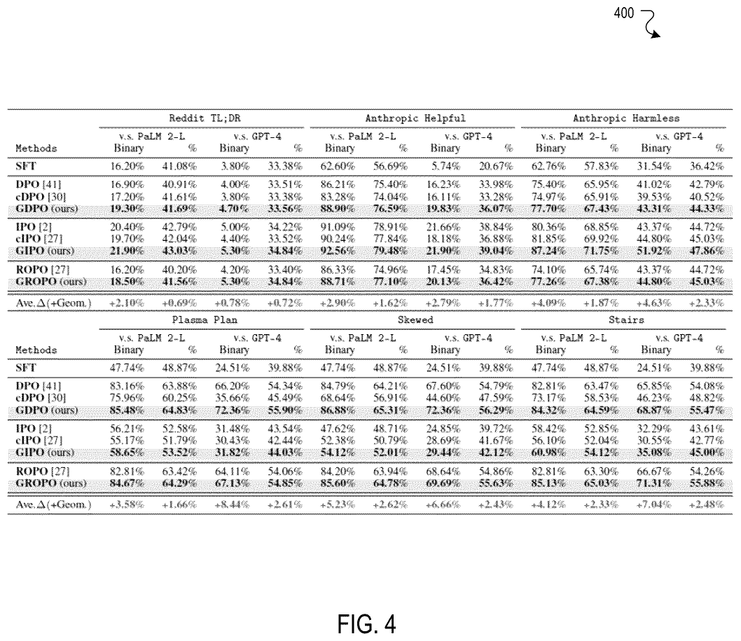

FIG. 4 illustrates an example 400 of the performance of example generative neural networks that have been trained using the described techniques.

In particular, FIG. 4 illustrates results of side-by-side comparisons of the performance of generative neural networks trained using the described techniques on various data sets relative to the performance of the same generative neural networks fine-tuned on the same data sets without using soft preference scores, i.e., using objectives that only use “hard” preferences.

In particular, in the example 400, the performance for a given training technique is measured by determining how often an output generated by a given fine-tuned neural network that has been fine-tuned using the given training technique is preferred (by both a “binary” evaluator and a “%” evaluator that predicts the probability that a given output is preferred) to an output generated by a baseline, much larger generative neural network. Thus, the performance measures how much a given training techniques improves the ability of a small generative neural network to generate outputs that are preferred to those of a much larger generative neural network.

As can be seen from the example of FIG. 4, training using “geometric” objectives that incorporate soft preference scores offers significant improvement relative to training using conventional approaches and relative to using “pre-trained” generative neural networks that are not fine-tuned (i.e., relative to the supervised fine-tuning (SFT) baseline).

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers and for training a target generative neural network that is configured to generate output data items in response to input prompts, the method comprising:
obtaining a set of one or more training examples, each training example comprising (i) a first training data item, (ii) a second training data item, (iii) a training prompt, and (iv) a preference score indicating a degree to which the first training data item is preferred over the second training data item as a response to the training prompt;
for each training example:
processing the training prompt using the target generative neural network to generate a first likelihood score for the first training data item; and
processing the training prompt using the target generative neural network to generate a second likelihood score for the second training data item;
training the target generative neural network using, for each training example, the first likelihood score for the first training data item in the training example, the second likelihood score for the second training data item in the training example, and the preference score in the training example.

2. The method of claim 1, wherein:
for one or more of the training examples, the preference score is based on a user input specifying the preference score received prior to or during the training of the target generative neural network.

3. The method of claim 1, wherein:
for one or more of the training examples:
the preference score has been generated by combining a plurality of initial preference scores, wherein each initial preference score has been specified by a corresponding user input that indicates a preference between the first training data item and the second training data item given the training prompt.

4. The method of claim 1, wherein:
for one or more of the training examples, the preference score has been generated by processing (i) the first training data item, (ii) the second training data item, and (iii) the training prompt using a preference generative neural network.

5. The method of claim 1, wherein training the neural network comprises training the target generative neural network on an objective that encourages the target generative neural network, to for each training example, assign a higher likelihood to a preferred data item for the input prompt in the training example than to a non-preferred data item for the input prompt in the training example.

6. The method of claim 5, wherein the objective represents a likelihood score for the preferred data item as a first weighted geometric average of the first likelihood score and the second likelihood score, wherein a weight for the first likelihood score in the first weighted geometric average is equal to the preference score.

7. The method of claim 6, wherein the objective represents a likelihood score for the non-preferred data item as a second weighted geometric average of the first likelihood score and the second likelihood score, wherein a weight for the first likelihood score in the second weighted geometric average is equal to one minus the preference score.

8. The method of claim 5, wherein the objective penalizes the target generative neural network for assigning likelihoods that deviate from likelihoods assigned by a reference generative neural network.

9. The method of claim 1, further comprising, for each training example:
processing the training prompt using a reference generative neural network to generate a first reference likelihood score for the first training data item; and
processing the training prompt using the reference generative neural network to generate a second reference likelihood score for the second training data item, wherein:
training the target generative neural network comprises:
training the target generative neural network using, for each training example, the first likelihood score and the first reference likelihood score for the first training data item in the training example, the second likelihood score and the second reference likelihood score for the second training data item in the training example, and the preference score.

10. The method of claim 9, wherein the reference generative neural network has a same architecture as the neural network but different parameters.

11. The method of claim 9, wherein training the neural network comprises training the neural network on an objective function that is based on, for each training example:
(i) a first ratio between the first likelihood score and the first reference likelihood score for the first training data item in the training example,
(ii) a second ratio between the second reference likelihood score and the second likelihood score for the second training data item in the training example, and
(iii) the preference score.

12. The method of claim 11, wherein the objective function comprises a first term that measures a product of the first and second ratio and a weight for the first term that is based on the preference score.

13. The method of claim 11, wherein the objective function comprises a first term that measures a logarithm of a difference between the first and second ratio and a weight for the first term that is based on the preference score.

14. The method of claim 1, wherein training the target generative neural network comprises training the target generative neural network on an objective that represents the first training data item and the second data item as respective samples from respective weighted geometric averages of policies weighted using the preference score.

15. The method of claim 1, wherein the preference score is a non-binary value within a predetermined range.

16. The method of claim 1, wherein the preference score is a value between zero and one, exclusive.

17. The method of claim 1, wherein prior to the training on the set of one or more training examples, the target generative neural network has been trained on one or training tasks.

18. The method of claim 17, wherein the training tasks comprise one or more of unsupervised learning tasks or supervised fine-tuning tasks.

19. A computer-implemented method of generating a data item, comprising:
obtaining a new input prompt; and
processing the new input prompt using a trained target generative neural network, wherein the target generative neural network has been trained by performing operations comprising:
obtaining a set of one or more training examples, each training example comprising (i) a first training data item, (ii) a second training data item, (iii) a training prompt, and (iv) a preference score indicating a degree to which the first training data item is preferred over the second training data item as a response to the training prompt;
for each training example:
processing the training prompt using the target generative neural network to generate a first likelihood score for the first training data item; and
processing the training prompt using the target generative neural network to generate a second likelihood score for the second training data item;
training the target generative neural network using, for each training example, the first likelihood score for the first training data item in the training example, the second likelihood score for the second training data item in the training example, and the preference score in the training example.

20. A computer-implemented method of generating a data item, the method comprising:
receiving an input prompt; and
processing the input prompt using a target generative neural network to generate the data item, wherein the target generative neural network is optimized to generate output data items in response to input prompts, the target generative neural network being optimized such that a contribution of preference data to an objective function used for optimizing the target generative neural network is determined based on a preference score associated with the preference data, the preference data comprising a first training data item, a second training data item, a training prompt, and the preference score representing a degree of preference for the first training data item over the second training data item as a response to the training prompt.

21. The method of claim 20, wherein the target generative neural network generates an output token sequence from an input token sequence including the input prompt, and wherein the target generative neural network is configured to process the input token sequence to generate for each position in the output token sequence, a respective score for each token in a vocabulary of output tokens.

22. The method of claim 21, wherein the data item comprises a language and/or image and/or audio response to the prompt.

23. The method of claim 21, wherein the input prompt comprises an input image and wherein the output data item is classification data item that identifies a label for an object class to which the input belongs, and wherein the object class corresponds to a class of object depicted in the input image.
